(19) United States
(12) Patent Application Publication
(10) Pub. No.: US 2019/0004966 A1
(43) Pub. Date: Jan. 3, 2019

(54) SEMICONDUCTOR DEVICE

(71) Applicant: RENESAS ELECTRONICS CORPORATION, Tokyo (JP)

(72) Inventor: Takashi ABEMATSU, Tokyo (JP)

(21) Appl. No.: 15/981,540

(22) Filed: May 16, 2018

(30) Foreign Application Priority Data
Jun. 28, 2017 (JP) 2017-126535

(51) Int. Cl. G06F 12/1027

(52) U.S. Cl. CPC G06F 12/1027; G06F 2212/1008

(57) ABSTRACT

A semiconductor device includes associative memory, associated memory, a conversion register, a controller, and a synthetic data output unit. The associative memory searches whether input search data hits entry data stored in every row of a memory cell array or not, and outputs address information corresponding to hit entry data. The associated memory is accessibly provided according to address information in the associative memory and stores associated data corresponding to the entry data. The conversion register is capable of converting address information output from the associative memory into different address information. The controller accesses the associated memory based on address information in accordance with an output result from the conversion register and acquires associated data corresponding to the entry data. The synthetic data output unit that outputs synthetic data outside by synthesizing the address information output from the associative memory and associated data output from the associated memory.

### CROSS-REFERENCE TO RELATED APPLICATIONS

The disclosure of Japanese Patent Application No. 2017-126535 filed on Jun. 28, 2017 including the specification, drawings and abstract is incorporated herein by reference in its entirety.

### BACKGROUND

The present disclosure relates to a semiconductor device and more particularly to associative memory.

A storage device referred to as associative memory or CAM (Content Addressable Memory) searches stored data words for a data word matching a search word and outputs the address of a matching data word, if any.

Particularly, CAM is widely used for routers for networks such as the Internet to search for addresses and control accesses (patent literature 1).

With respect to this, patent literature 1 discloses the configuration that includes, in addition to CAM, associated memory (AM) that stores associated data associated with data words.

Generally, the associated memory is capable of accessing associated data by using the same address as CAM.

The associated memory requires ensuring large capacity similarly to CAM. Patent literature 1 selectively uses a plurality of arrays provided to ensure the large capacity.

However, the associated memory is forced to maintain one-to-one relation with CAM. The relation lacks the degree of freedom.

### Patent Literature

U.S. Pat. No. 7,281,085

### SUMMARY

The present disclosure has been made in consideration of the foregoing. It is an object of the disclosure to provide a semiconductor device capable of highly flexible access to the associated memory.

These and other objects and novel features may be readily ascertained by referring to the following description of the present specification and appended drawings.

A semiconductor device according to an aspect of the present disclosure includes associative memory, associated memory, a conversion register, a controller, and a synthetic data output unit. The associative memory searches whether input search data hits entry data stored in every row of a memory cell array, and outputs address information corresponding to hit entry data. The associated memory is accessibly provided according to address information in the associative memory and stores associated data corresponding to the entry data. The conversion register is capable of converting address information output from the associative memory into different address information. The controller accesses the associated memory based on address information in accordance with an output result from the conversion register and acquires associated data corresponding to the entry data. The synthetic data output unit outputs synthetic data outside by synthesizing the address information output from the associative memory and the associated data output from the associated memory.

An embodiment can provide a semiconductor device capable of highly flexible access to associated memory.

### BRIEF DESCRIPTION OF THE DRAWINGS

FIG. 1 is a drawing illustrating a configuration of communication equipment 100 according to a first embodiment;

FIG. 2 is a drawing illustrating a search operation of the communication equipment 100 based on the first embodiment;

FIG. 3 is a drawing illustrating a process flow of a controller 400 based on the first embodiment;

FIG. 4 is a drawing illustrating a configuration of communication equipment 101 based on a second embodiment;

FIG. 5 is a drawing illustrating an access table stored in an AD register 510 according to the second embodiment;

FIG. 6 is a drawing illustrating a process flow of the controller 400 based on the second embodiment;

FIG. 7 is a drawing illustrating a communication packet based on a modification of the second embodiment;

FIG. 8 is a conceptual diagram illustrating transmission of a communication packet based on the modification of the second embodiment; and

FIG. 9 is a drawing illustrating a configuration of communication equipment 110 based on a third embodiment;

### DETAILED DESCRIPTION

Embodiments will be described in further detail with reference to the accompanying drawings. The same or comparable parts in the drawings are depicted by the same reference numerals and a detailed description is omitted for simplicity.

### First Embodiment

Overall Configuration of the Communication Equipment 100

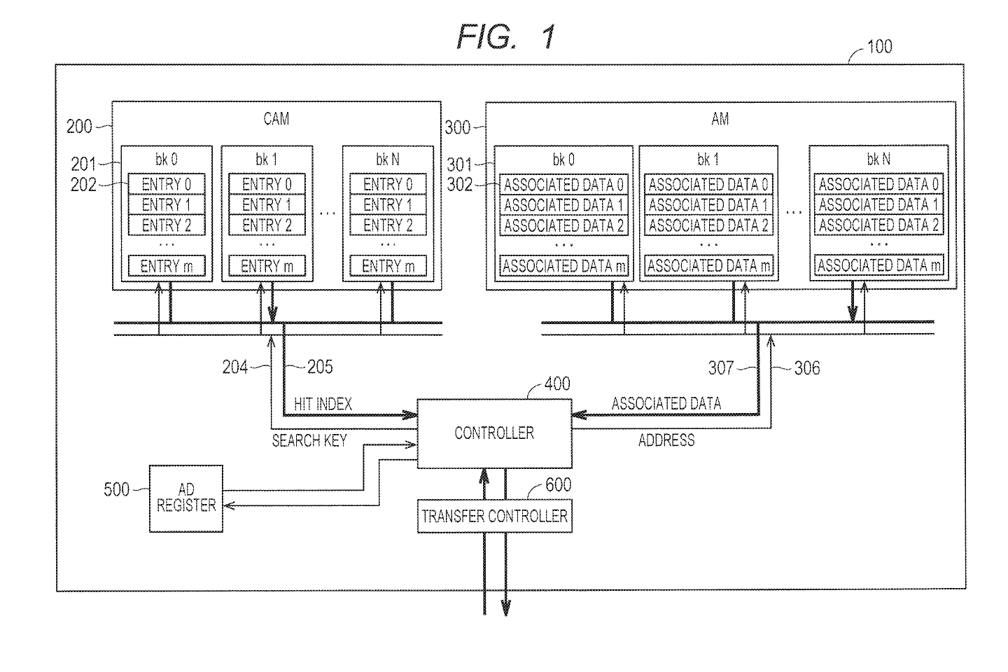

FIG. 1 is a drawing illustrating a configuration of the communication equipment 100 according to the first embodiment.

As illustrated in FIG. 1, the communication equipment 100 is available as a communication device such as a switch or a router.

The communication equipment 100 includes associative memory 200, associated memory 300, a controller 400, an AD register 500, and a transfer controller 600.

For example, the controller 400 is configured as a CPU (Central Processing Unit) and controls the entire equipment.

The controller 400 provides various functions in cooperation with a program stored in unshown general-purpose memory. For example, the general-purpose memory can be configured as DRAM (Dynamic Random Access Memory) and provides an operating system (OS) in cooperation with the controller 400.

The controller 400 exchanges information with the adjacent communication equipment and maintains or manages information needed for transfer processes.

The transfer controller 600 transfers communication packets in accordance with instructions from the controller 400. The transfer controller 600 includes dedicated hardware such as an ASIC (Application Specific Integrated Circuit) circuit or an NPU (Network Processing Unit) specialized for transfer processes.

The controller 400 accesses the associative memory 200, the associated memory 300, and the AD register 500 to acquire information needed for the transfer process.

In the example, the associative memory 200 uses a CAM device.

The associated memory 300 is configured as DRAM.

The associative memory 200 is configured as a plurality of blocks 201.

The example uses block numbers bk0 through bkN.

Each block 201 includes a memory cell array. Each row of the memory cell array stores entry data 202. The example shows that each row stores entry data with entry numbers 0 through m.

In the example, the controller 400 supplies a search key 204 to each block 201 in the associative memory 200. A search process is performed on each block 201 to determine whether entry data matching the search key 204 is stored. Suppose it is determined that each block 201 contains matching (hit) entry data. In this case, address information is output as a hit index 205 to the controller 400. The address information includes a block number and an entry number. The block number indicates a block to which the hit entry data belongs. The entry number is assigned to the entry data.

The associated memory 300 includes a plurality of blocks 301.

The present example provides blocks assigned block numbers bk0 through bkN. The associated memory 300 is accessibly provided in accordance with the address information about the associative memory 200. The example uses the same address space, but is not limited thereto. A smaller address space may be used.

Each block 301 includes a memory cell array. Each row of the memory cell array stores associated data 302. In the example, each row stores the associated data having associated data numbers 0 through m. The address information about each of associated data numbers 0 through m corresponds to the address information about entry numbers 0 through m in each block of the associative memory 200.

In the present example, the controller 400 transmits the address information to access the associated memory 300.

The associated memory 300 reads associated data 307 based on the address information and outputs the associated data 307 to the controller 400.

The AD register 500 includes register information used to convert the hit index 205, namely the address information output from the associative memory 200, into another address information.

The controller 400 can convert the hit index 205 as the address information into another address information based on the register information stored in the AD register 500.

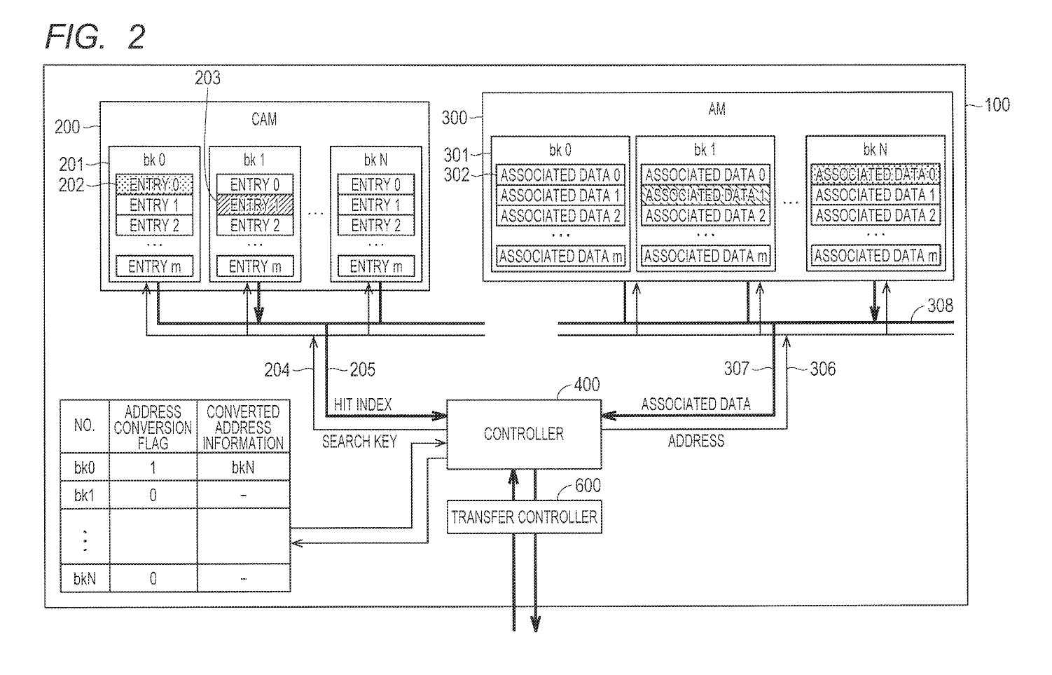

FIG. 2 is a drawing illustrating a search operation of the communication equipment 100 based on the first embodiment.

As illustrated in FIG. 2, the AD register 500 stores an address conversion table as the register information according to the present example.

Specifically, the address conversion table contains a block number, an address conversion flag, and converted address information.

Specifically, the present example registers block number bk0, address conversion flag “1,” and block number bkN as the converted address information associated with each other.

Each of the other block numbers bk1 through bkN is registered to be associated with address conversion flag “0” as no converted address information.

Address conversion flag “0” signifies that the address information is not converted. Address conversion flag “1” signifies that the address information is converted.

The converted address information is used to convert the address when the address conversion flag is set to “1.”

Namely, the address conversion table represents the address conversion flag “1” indicating that the address is converted, and, specifically, block bkN is specified as the converted address information when the hit index 205 contains block number bk0.

The address conversion table represents the address conversion flag “0” indicating that the address is not converted, when the hit index 205 contains any one of block numbers bk1 through bkN.

The controller 400 converts the address information based on the address conversion table.

As an example, the description below explains a case where entry data assigned entry number 1 in the block assigned block number bk1 in the associative memory 200 hits the search key 204.

In this case, the associative memory 200 outputs the hit index 205 (address information) containing data of block number bk1 and entry number 1 to the controller 400.

The controller 400 receives the hit index 205 from the associative memory 200, accesses the AD register 500, and acquires the register information (address conversion table) corresponding to the block number indicated by the hit index 205.

Address conversion flag “0” corresponds to block number bk1 indicated by the hit index 205 (address information). The controller 400 therefore outputs the address information as is to the associated memory 300.

The associated memory 300 outputs the associated data having associated data number 1 at block number bk1 to the controller 400 based on the address information input from the controller 400.

The controller 400 outputs the hit index 205 (address information) acquired from the associative memory 200 and the associated data 307 acquired from the associated memory 300 to the transfer controller 600.

The transfer controller 600 synthesizes the address information and the associated data 307 output from the controller 400 to generate a communication packet and transmits it outside.

The description below explains another example where entry number 0 hits the search key 204 at block number bk0 in the associative memory 200.

In this case, the associative memory 200 outputs the hit index 205 (address information) corresponding to entry number 0 at block number bk0 to the controller 400.

The controller 400 receives the hit index 205 from the associative memory 200, accesses the AD register 500, and acquires the register information (address conversion table).

The controller 400 converts the address because address conversion flag “1” corresponds to block number bk0 indicated by the hit index 205 (address information). Specifically, the block number contained in the hit index 250 (address information) is converted into the converted address information, namely, the address information specifying block number bkN. The controller 400 outputs the converted address information to the associated memory 300.

The associated memory 300 outputs the associated data having associated data number 0 in block number bkN to the controller 400 based on the converted address information input from the controller 400.

The controller 400 outputs the hit index 205 (address information) acquired from the associative memory 200 and the associated data 307 acquired from the associated memory 300 to the transfer controller 600.

The transfer controller 600 synthesizes the address information and the associated data 307 output from the controller 400 to generate a communication packet and transmits the communication packet outside.

The above-mentioned technique can convert predetermined address information, if any, into different address information to acquire the associated data 307 based on the converted address information.

A highly flexible access to the associated memory 300 is therefore available by changing the register information stored in the AD register 500 to any value as needed.

As has been described, block number bkN is specified as the converted address information in accordance with the hit index 205 (address information) related to block number bk0 to read associated data number 0 for block number bkN. Alternatively, the entire block (all associated data contained in the block) for block number bkN may be specified.

The associated data can maintain the one-to-many relation to the entry data instead of the one-to-one relation. It is possible to acquire large-capacity associated data as needed.

As has been described in the first embodiment, the number of blocks contained in the associative memory 200 equals the number of blocks contained in the associated memory, but not limited thereto. The converted address information corresponding to a plurality of hit indexes related to different block numbers may specify the same block number. For example, the converted address information corresponding to the hit index related to block number Bk0 and the converted address information corresponding to the hit index related to block number Bk1 may specify the same block number BkN.

It is possible to decrease the number of blocks in the associated memory, namely, the capacity of the associated memory. As a result, a chip area can be reduced.

Process Flow

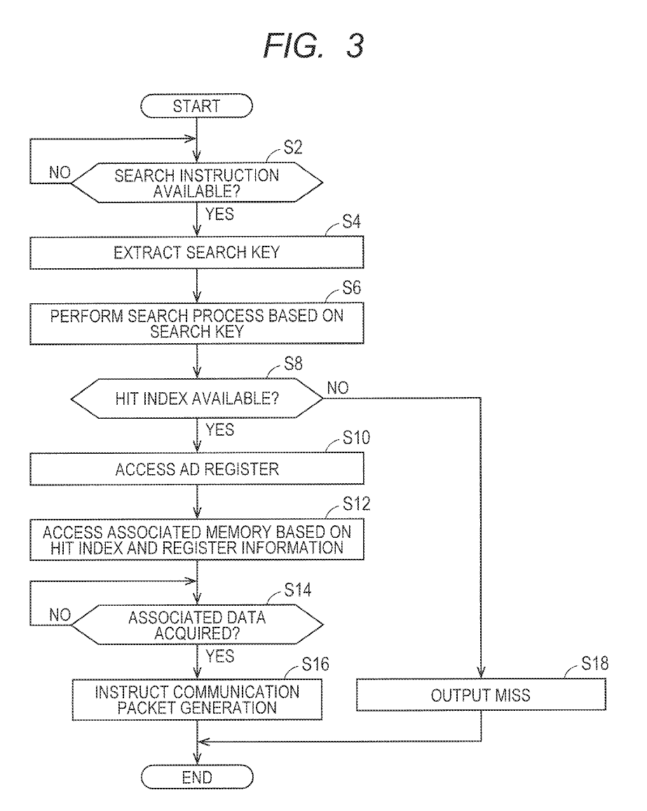

FIG. 3 is a drawing illustrating a process flow of the controller 400 based on the first embodiment.

As illustrated in FIG. 3, the controller 400 determines whether a search instruction is available (S2).

The controller 400 may determine that a search instruction is available (YES at S2), and then extracts the search key 204 (S4).

The controller 400 performs a search process based on the search key 204 (S6).

The controller 400 determines whether the hit index 205 is available (S8).

At S8, the controller 400 may determine that the hit index 205 is available (YES at S8), and then accesses the AD register 500 to acquire the register information (address conversion table) (S10).

The controller 400 generates address information to access the associated memory 300 based on the hit index 205 and the register information (address conversion table) and performs an access process based on the generated address information (S12).

Specifically, as described with reference to FIG. 2, the controller 400 determines whether the hit index 205 corresponds to predetermined address information, and converts the predetermined address information, if any, into different address information. The controller 400 performs the access process that outputs the converted address information to the associated memory 300.

The controller 400 determines whether the associated data 307 is acquired from the associated memory 300 (S14).

The controller 400 may determine that the associated data 307 is acquired from the associated memory 300 (YES at S14), and then instructs the transfer controller 600 to generate a communication packet (S16).

The transfer controller 600 follows the instruction to generate a communication packet from the controller 400, generates a communication packet by synthesizing the hit index (address information) and the associated data, and transmits the communication packet outside.

The process then terminates (end).

At S8, the controller 400 may determine that the hit index 205 is unavailable (NO at S8), and then instructs the transfer controller 600 to output a miss (S18).

The transfer controller 600 follows the miss output instruction from the controller 400 and outputs a miss outside.

The process then terminates (end).

### Second Embodiment

The above-mentioned first embodiment has described the technique that converts the address information as the hit index 205 output from the associative memory 200 into different address information based on the register information stored in the AD register 500 and acquires the associated data 307 from the associated memory 300 based on the different address information.

The second embodiment will describe a technique that variably acquires associated data without converting the address information as the hit index 205 output from the associative memory 200.

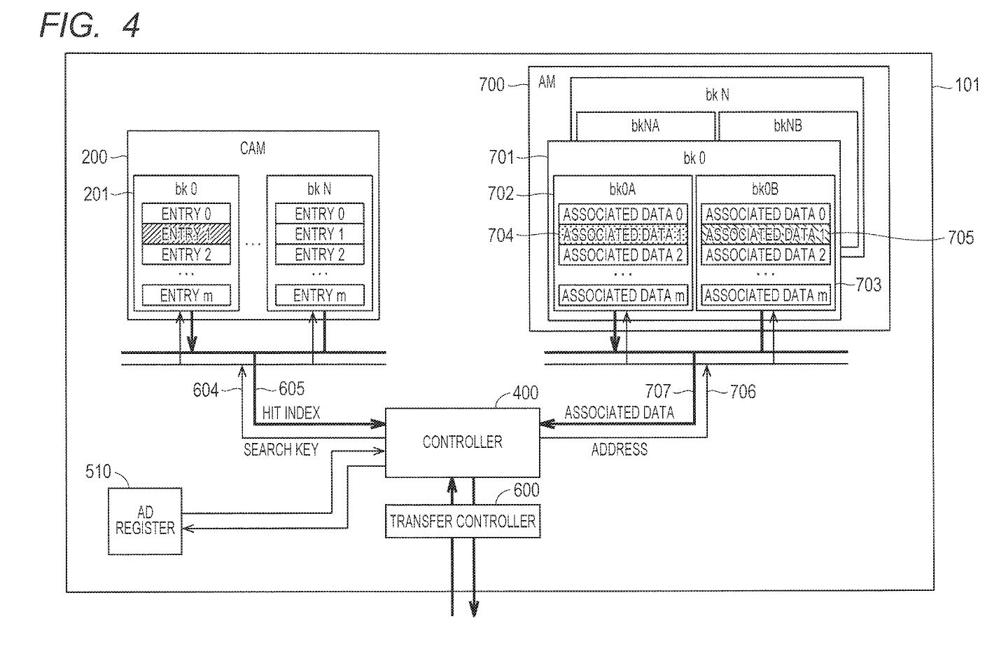

FIG. 4 is a drawing illustrating a configuration of communication equipment 101 based on the second embodiment.

As illustrated in FIG. 4, the communication equipment 101 is available as a communication device such as a switch or a router similarly to the communication equipment 100.

The communication equipment 101 differs from the communication equipment 100 in that the associated memory 300 is changed to associated memory 700. Nothing is unchanged for the rest as described with reference to FIG. 1 and a detailed description is omitted.

The associated memory 700 includes blocks bk0 through bkN.

Block bk0 of the associated memory 700 includes sub-blocks bk0A and bk0B. The same applies to the other blocks.

As will be described later, sub-blocks bk0A and bk0B are specified based on a selection flag stored in the AD register 510.

As described in the first embodiment, the associated memory 700 uses the same address space as the associative memory 200.

As an example, the description below explains a case where entry number 1 hits the search key 204 at block number bk0 in the associative memory 200.

The associative memory 200 thereby outputs the hit index 205 (address information) corresponding to entry number 1 in block number bk0 to the controller 400.

The controller 400 receives the hit index 205 from the associative memory 200 and accesses the associated memory 700 to acquire the associated data.

At this time, the controller 400 generates address information to access the associated memory 700 based on the access table stored in the AD register 510 and accesses the associated memory 700.

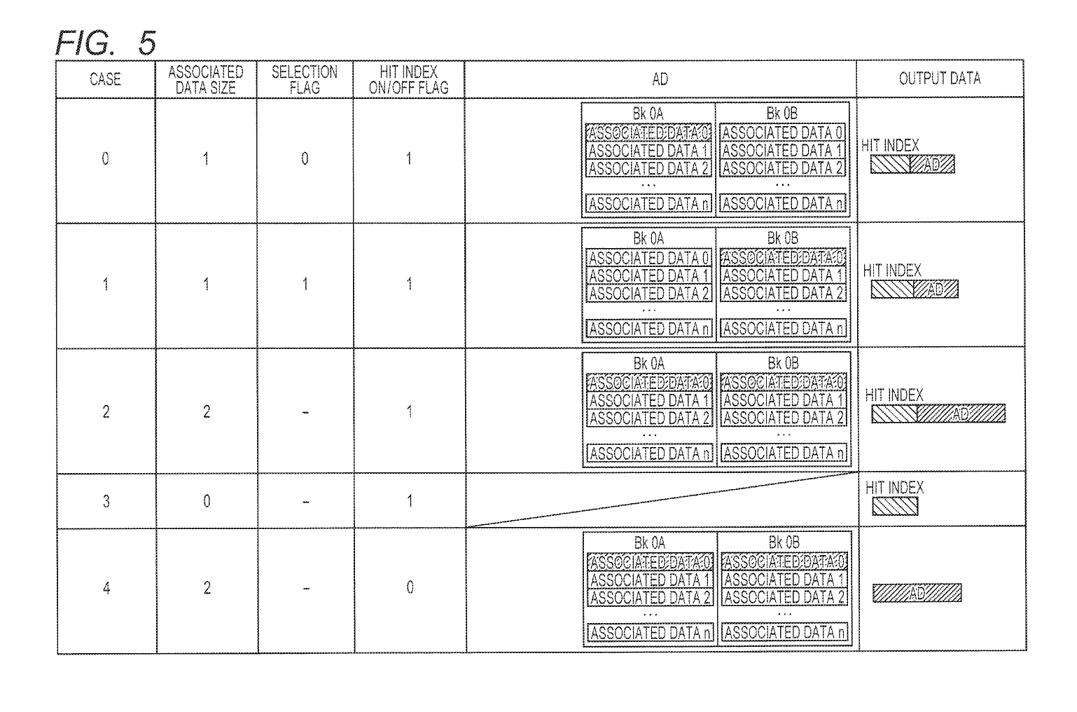

FIG. 5 is a drawing illustrating the access table stored in the AD register 510 according to the second embodiment.

As illustrated in FIG. 5, the access table contains five cases of access information.

The access information of case 0 is configured as associated data size “1,” selection flag “0,” and hit index on/off flag “1.”

In this case, the associated data size read from the associated memory 700 corresponds to a normal size. The “normal size” here signifies the minimum unit usable as the data size, namely, the associated data size corresponding to one sub-block.

The selection flag selects a sub-block of block bk to be accessed.

In the present example, selection flag “0” selects sub-block “A” and selection flag “1” selects sub-block “B.” According to the example, sub-block “A” is selected because of selection flag “0.”

Hit index on/off flag “1” signifies that the hit index 205 is contained in transfer data output from the transfer controller 600. Hit index on/off flag “0” signifies that the hit index 205 is not contained in transfer data output from the transfer controller 600.

Namely, case 0 outputs the associated data and the hit index for sub-block “A.”

The access information of case 1 is configured as associated data size “1,” selection flag “1,” and hit index on/off flag “1.”

In this case, the associated data size read from the associated memory 700 corresponds to the normal size.

The sub-block “B” is selected based on the selection flag “1”. Hit index on/off flag “1” signifies that the hit index 205 is contained in transfer data output from the transfer controller 600. Hit index on/off flag “0” signifies that the hit index 205 is not contained in transfer data output from the transfer controller 600.

Namely, case 1 outputs the associated data and the hit index for sub-block “B.”

The access information of case 2 is configured as associated data size “2,” no selection flag, and hit index on/off flag “1.”

In this case, the associated data size read from the associated memory 700 doubles the normal size, namely, the associated data size corresponding to two sub-blocks.

No selection flag allows the associated data to be read from both sub-blocks of block bk to be accessed. Hit index on/off flag “1” signifies that the hit index is contained in transfer data output from the transfer controller 600.

Namely, case 2 outputs the associated data and the hit index for both sub-blocks “A” and “B.”

The access information of case 3 is configured as associated data size “0,” no selection flag, and hit index on/off flag “1.”

In this case, the associated data size read from the associated memory 700 is 0, signifying that no associated data is read.

The selection flag is unavailable.

Hit index on/off flag “1” signifies that only the hit index is contained in transfer data output from the transfer controller 600. No associated data is contained.

Namely, case 3 outputs only the hit index.

The access information of case 4 is configured as associated data size “2,” no selection flag, and hit index on/off flag “0.”

In this case, the associated data size read from the associated memory 700 doubles the normal size. No selection flag allows the associated data to be read from both sub-blocks of block bk to be accessed. Hit index on/off flag “0” signifies that no hit index is contained in transfer data output from the transfer controller 600 and only the associated data is contained.

Namely, case 4 outputs only the associated data.

A search profile contained in the search instruction selects any one of cases 1 through 4 of the access information.

The example shows that entry number 1 hits the search key 604 at block number bk0 in the associative memory 200.

The associative memory 200 therefore outputs a hit index 605 (address information) containing data of block number bk0 and entry number 1 to the controller 400.

The controller 400 receives the hit index 605 from the associative memory 200.

The controller 400 acquires the access information from the AD register 510 based on the search profile. The description below explains an example of acquiring the access information corresponding to case 0.

In this case, the controller 400 receives the hit index 605 (address information) related to block number bk0. The access information of case 0 contains associated data size “1” and selection flag “0.” The controller 400 therefore generates and outputs the address information to access sub-block bk0A of block number bk0 in the associated memory 700.

The associated memory 700 outputs the associated data having associated data number 1 of sub-block bk0A of block number bk0 to the controller 400 based on the address information from the controller 400.

Because of hit index on/off flag “1,” the controller 400 outputs the hit index 605 (address information) acquired from the associative memory 200 and associated data 707 acquired from the associated memory 700 to the transfer controller 600.

The transfer controller 600 synthesizes the address information and the associated data 707 output from the controller 400 to generate a communication packet and transmits the communication packet outside.

As another example, the controller 400 acquires the access information from the AD register 510 based on the search profile. The description below explains an example of acquiring the access information corresponding to case 1.

In this case, the controller 400 receives the hit index 605 (address information) related to block number bk0. The access information of case 1 contains associated data size “1” and selection flag “1.” The controller 400 therefore generates and outputs the address information to access sub-block bk0B of block number bk0 in the associated memory 700.

The associated memory 700 outputs the associated data having associated data number 1 of sub-block bk0B of block number bk0 to the controller 400 based on the address information from the controller 400.

Because of hit index on/off flag “1,” the controller 400 outputs the hit index 605 (address information) acquired from the associative memory 200 and associated data 707 acquired from the associated memory 700 to the transfer controller 600.

The transfer controller 600 synthesizes the address information and the associated data 707 output from the controller 400 to generate a communication packet and transmits the communication packet outside.

As another example, the controller 400 acquires the access information from the AD register 510 based on the search profile. The description below explains an example of acquiring the access information corresponding to case 2.

In this case, the controller 400 receives the hit index 605 (address information) related to block number bk0. The access information of case 2 contains associated data size “2” and no selection flag. The controller 400 therefore outputs the address information to access each of sub-blocks bk0A and bk0B of block number bk0 in the associated memory 700.

The associated memory 700 outputs two pieces of associated data having associated data number 1 in sub-blocks bk0A and bk0B of block number bk0 based on the address information input from the controller 400.

Because of hit index on/off flag “1,” the controller 400 outputs the hit index 605 (address information) acquired from the associative memory 200 and a plurality of pieces of associated data 707 acquired from the associated memory 700 to the transfer controller 600.

The transfer controller 600 synthesizes the address information and the pieces of associated data 707 output from the controller 400 to generate a communication packet and transmits the communication packet outside.

As another example, the controller 400 acquires the access information from the AD register 510 based on the search profile. The description below explains an example of acquiring the access information corresponding to case 3.

In this case, the controller 400 receives the hit index 605 (address information) related to block number bk0. The access information of case 3 contains associated data size “0” and no selection flag. The controller 400 therefore does not access the associated memory 700.

Because of hit index on/off flag “1,” the controller 400 outputs the hit index 605 (address information) acquired from the associative memory 200 to the transfer controller 600.

The transfer controller 600 transmits the address information output from the controller 400 outside so that the communication packet contains the address information.

As another example, the controller 400 acquires the access information from the AD register 510 based on the search profile. The description below explains an example of acquiring the access information corresponding to case 4.

In this case, the controller 400 receives the hit index 605 (address information) related to block number bk0. The access information of case 4 contains associated data size “2” and no selection flag. The controller 400 therefore outputs the address information to access each of sub-blocks bk0A and bk0B of block number bk0 in the associated memory 700.

The associated memory 700 outputs two pieces of associated data having associated data number 1 in sub-blocks bk0A and bk0B of block number bk0 based on the address information input from the controller 400.

Because of hit index on/off flag “0,” the controller 400 does not output the hit index 605 (address information) acquired from the associative memory 200 but outputs only the pieces of associated data 707 acquired from the associated memory 700 to the transfer controller 600.

The transfer controller 600 synthesizes the pieces of associated data 707 output from the controller 400 to generate a communication packet and transmits the communication packet outside.

Process Flow

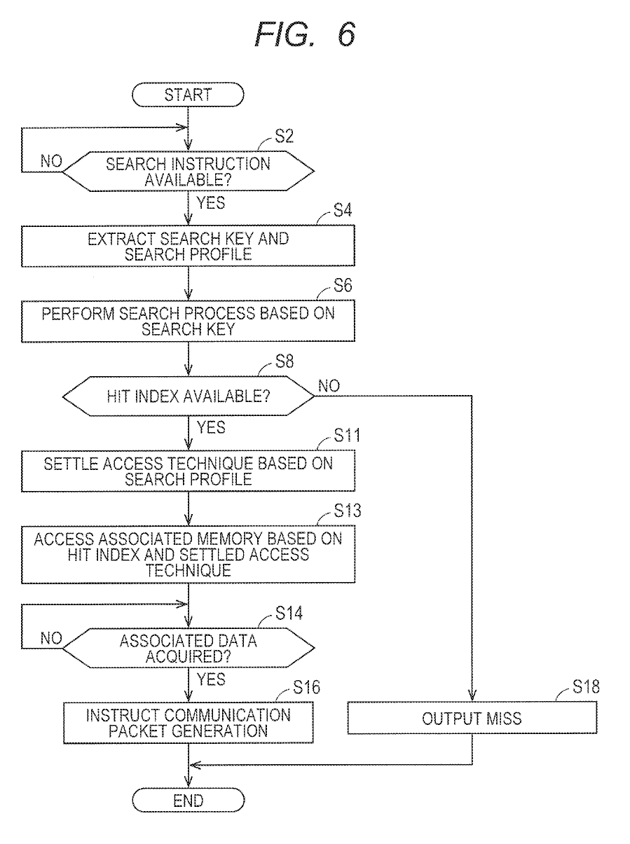

FIG. 6 is a drawing illustrating a process flow of the controller 400 based on the second embodiment.

As illustrated in FIG. 6, the controller 400 determines whether a search instruction is available (S2).

The controller 400 may determine that a search instruction is available (YES at S2), and then extracts the search key 204 and the search profile (S4).

The controller 400 performs a search process based on the search key 204 (S6).

The controller 400 determines whether the hit index 205 is available (S8).

At S8, the controller 400 may determine that the hit index is available (YES at S8), and then settles the access technique based on the search profile (S11). Specifically, the controller 400 accesses the AD register 510 and acquires the access information of the case based on the search profile.

When the search profile specifies case 0, the access technique on the associated memory 700 performs the access process that reads the normal size as the associated data size. Sub-block “A” is selected because of selection flag “0.”

When the search profile specifies case 1, the access technique on the associated memory 700 performs the access process that reads the normal size as the associated data size. Sub-block “B” is selected because of selection flag “1.”

When the search profile specifies case 2, the access technique on the associated memory 700 performs the access process that reads double the normal size because of associated data size “2.” Namely, both sub-blocks “A” and “B” are selected.

When the search profile specifies case 3, the associated memory 700 is not accessed.

When the search profile specifies case 4, the access technique on the associated memory 700 performs the access process that reads double the normal size because of associated data size “2.” Namely, both sub-blocks “A” and “B” are selected.

The controller 400 performs the access process on the associated memory 300 based on the hit index and the settled access technique (S12).

The controller 400 determines whether the associated data is acquired from the associated memory 300 (S14).

The controller 400 may determine that the associated data is acquired from the associated memory 300 (YES at S14), and then instructs the transfer controller 600 to generate a communication packet (S16).

The transfer controller 600 follows the instruction to generate a communication packet from the controller 400, generates a communication packet by synthesizing the hit index (address information) and the associated data, and transmits the communication packet outside.

When the search profile specifies case 0, the process generates a communication packet by synthesizing the hit index (address information) and the associated data, and transmits the communication packet outside.

When the search profile specifies case 1, the process generates a communication packet by synthesizing the hit index (address information) and the associated data, and transmits the communication packet outside.

When the search profile specifies case 2, the process generates a communication packet by synthesizing the hit index (address information) and the associated data corresponding to double the normal size, namely, two sub-blocks, and transmits the communication packet outside.

When the search profile specifies case 3, the process generates a communication packet containing only the hit index and transmits the communication packet outside.

When the search profile specifies case 4, the process generates a communication packet containing only the associated data of two sub-blocks and transmits the communication packet outside.

The process then terminates (end).

At S8, the controller 400 may determine that the hit index is unavailable (NO at S8), and then instructs the transfer controller 600 to output a miss (S18).

The process then terminates (end).

The process can change the access technique and variably acquire the associated data based on the information contained in the search profile without converting the address information as the hit index 205 output from the associative memory 200.

The search profile may be supplied each time a search instruction is issued or only when the associative memory table is generated before the search. Notice the case where the search profile is supplied only when the associative memory table is generated. In this case, the same access technique converts the address information as the hit index until the search profile is changed.

The second embodiment selects the information about the access technique stored in the AD register 510 based on the search profile. Moreover, other information such as the associated data size, the selection flag, and the hit index on/off flag may be stored corresponding to the block number. In this case, the information about the search profile is unneeded. The controller 400 can acquire associated data in compliance with an intended output technique for each hit index by converting the address information based on the block number contained in the hit index and the information about the corresponding AD register.

Modification

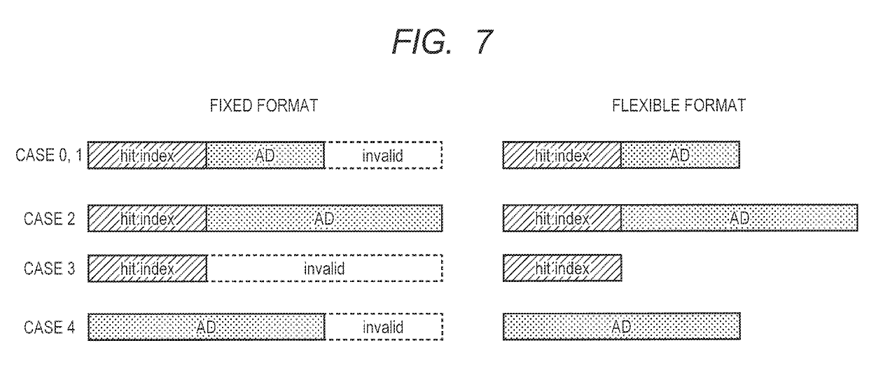

FIG. 7 is a drawing illustrating a communication packet based on a modification of the second embodiment.

As illustrated in FIG. 7, the communication packet corresponding to each case may use a fixed format. In this case, invalid data is inserted as a dummy into a part where data of a fixed format length is missing.

A flexible format length instead of the fixed format length can decrease a data amount of the communication packet.

For example, suppose the search profile contains cases 0 and 1. The transfer controller 600 then synthesizes the hit index (address information) and the associated data to generate a communication packet and transmits the communication packet outside.

Suppose the search profile contains case 2. The transfer controller 600 then synthesizes the hit index (address information) and the associated data of double the normal size, namely, the associated data of two sub-blocks to generate a communication packet and transmits the communication packet outside.

Suppose the search profile contains case 3. The transfer controller 600 then generates a communication packet containing only the hit index and transmits the communication packet outside.

Suppose the search profile contains case 4. The transfer controller 600 then generates a communication packet containing only the associated data of double the normal size, namely, the associated data of two sub-blocks and transmits the communication packet outside.

The transfer controller 600 edits the data size in a header of the communication packet and transmits the communication packet.

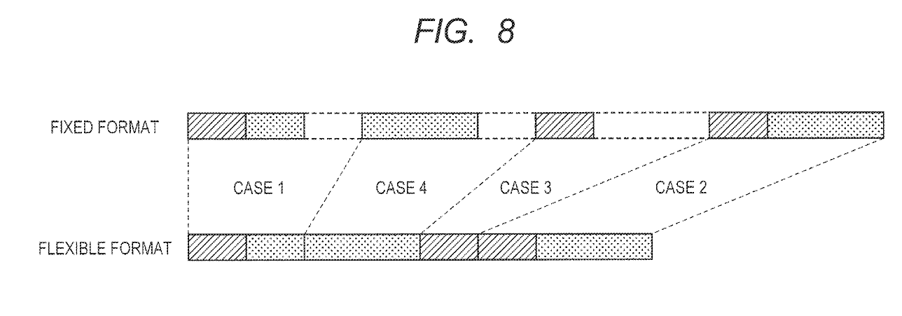

FIG. 8 is a conceptual diagram illustrating transmission of a communication packet based on the modification of the second embodiment.

As illustrated in FIG. 8, the description below explains an example of successively transmitting communication packets of the fixed format length in cases 1 through 4.

In this case, the entire length of the communication packets increases because invalid data is contained.

The communication packet of the flexible format length includes no area for invalid data. It is therefore possible to reduce the data amount of the communication packet and improve a transfer rate.

### Third Embodiment

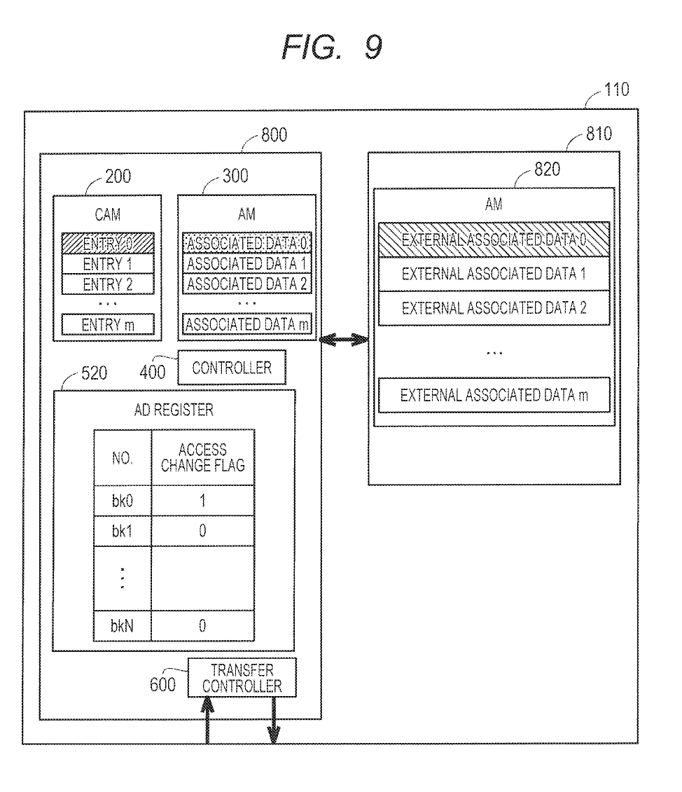

FIG. 9 is a drawing illustrating a configuration of communication equipment 110 based on the third embodiment.

As illustrated in FIG. 9, the communication equipment 110 is available as a communication device such as a switch or a router.

The present example illustrates the communication equipment 110 including two chips 800 and 810.

The chip 800 includes the associative memory 200, the associated memory 300, the controller 400, an AD register 520, and the transfer controller 600. The chip 800 is basically the same as described with reference to FIG. 1 and a detailed description is omitted.

The chip 810 is not integrated with the chip 800 but is provided outside as a different chip. The chip 810 indicates that associated memory 820 is provided.

The associated memory 820 is configured as DRAM, for example.

The associated memory 820 stores associated data outside (also referred to as external associated data).

Though unshown, the associated memory 820 also includes a plurality of blocks as described with reference to FIG. 1. The associated memory 820 uses the same address space as the associative memory 200.

The associated memory 820 includes a memory cell array as described with reference to FIG. 1. Every row of the memory cell array stores external associated data 302. The example shows that every row stores each of external associated data numbers 0 through m.

In the present example, the controller 400 of the chip 800 transmits address information to access the associated memory 820 of the chip 810.

The associated memory 820 outputs the external associated data to the controller 400 based on the address information.

The AD register 520 includes register information to access the associated memory by using the hit index 205 as the address information output from the associative memory 200.

The controller 400 accesses the associated memory based on the register information stored in the AD register 520 by using the hit index 205 as the address information.

Specifically, the access table contains a block number and an access change flag.

Specifically, the present example registers the address conversion flag associated with “1” corresponding to block number bk0.

Each of the other block numbers bk1 through bkN is registered to be associated with access change flag “0.”

Access change flag “1” signifies that the external associated memory 820 is accessed. Access change flag “0” signifies that the internal associated memory 300 is accessed.

Suppose the address information about block number bk0 is acquired as the hit index 205. In this case, the access table accesses the associated memory 820 because of access change flag “1.” Specifically, the controller 400 outputs the address information to the external chip 810 in order to acquire the external associated data in the associated memory 820.

The associated memory 820 outputs the external associated data to the controller 400.

The transfer controller 600 synthesizes the address information and the external associated data output from the controller 400 to generate a communication packet and transmits the communication packet outside.

Access change flag “1” signifies that the external associated memory 820 is accessed. Access change flag “0” signifies that the internal associated memory 300 is accessed.

Suppose the address information about block number bk0 is acquired as the hit index. In this case, the controller 400 accesses the associated memory 820 because of access change flag “1” according to the access table. Specifically, the controller 400 outputs the address information to the external chip 810 in order to acquire the external associated data in the associated memory 820.

The associated memory 820 outputs the external associated data to the controller 400.

The transfer controller 600 synthesizes the address information and the external associated data output from the controller 400 to generate a communication packet and transmits the communication packet outside.

Suppose the address information about block number bk1 is acquired as the hit index 205. In this case, the controller 400 accesses the internal associated memory 300 because of access change flag “0” according to the access table. Specifically, the controller 400 outputs the address information to the associated memory 300 in order to acquire the associated data in the associated memory 300.

The associated memory 300 outputs the associated data to the controller 400.

The transfer controller 600 synthesizes the address information and the external associated data output from the controller 400 to generate a communication packet and transmits the communication packet outside.

The above-mentioned configuration can switch between accessing the internal associated memory and accessing the external associated memory based on the register information stored in the AD register 520.

As an example, the internal associated memory may store associated data that stores instructions and data needed for high-speed processing. The external associated memory may store associated data that stores instructions and data capable of low-speed processing.

It is therefore possible to flexibly store the associated data according to utilization forms of the associated data. It is also possible to flexibly change the access technique based on the register information stored in the AD register 520.

While there have been described the specific preferred embodiments of the present disclosure, it is to be distinctly understood that the present disclosure is not limited thereto but may be otherwise variously embodied within the spirit and scope of the disclosure.

What is claimed is:

1. A semiconductor device comprising:
associative memory that searches whether input search data hits entry data stored in every row of a memory cell array or not, and outputs address information corresponding to hit entry data;
associated memory that is accessibly provided according to address information in the associative memory and stores associated data corresponding to the entry data;
a conversion register capable of converting the address information output from the associative memory into different address information;
a controller that accesses the associated memory based on the address information in accordance with an output result from the conversion register and acquires associated data corresponding to the entry data; and
a synthetic data output unit that outputs synthetic data outside by synthesizing the address information output from the associative memory and the associated data output from the associated memory.

2. The semiconductor device according to claim 1,
wherein, when predetermined address information is output from the associative memory, the conversion register converts address information into the different address information and outputs the different address information, and
wherein, when the address information output from the associative memory is not the predetermined address information, the conversion register outputs the address information without conversion.

3. A semiconductor device comprising:
associative memory that searches whether input search data hits entry data stored in every row of a memory cell array or not, and outputs address information corresponding to hit entry data;
associated memory that is accessibly provided according to address information in the associative memory and stores associated data corresponding to the entry data;
an additional register that stores access information to access the associated memory;
a controller that accesses the associated memory based on the access information stored in the additional register and address information and acquires associated data corresponding to the entry data; and
a synthetic data output unit that outputs synthetic data outside, the synthetic data being generated by synthesizing the address information output from the associative memory and the associated data output from the associated memory.

4. The semiconductor device according to claim 3,
wherein the associated memory includes a plurality of sub-blocks,
wherein the access information includes information about a data size of the associated data, and
wherein the controller accesses at least one of the sub-blocks in the associated memory based on information about the data size and the address information and acquires associated data corresponding to the entry data.

5. The semiconductor device according to claim 4,
wherein the access information further includes selection information to select one of the sub-blocks, and
wherein the controller accesses the associated memory based on information about a data size of the associated data, the selection information, and the address information and acquires associated data corresponding to the entry data.

6. The semiconductor device according to claim 4,
wherein, when a data size of the associated data is 1 or more, the controller accesses the associated memory based on the address information and acquires associated data corresponding to the entry data, and
wherein, when a data size of the associated data is 0, the controller does not access the associated memory.

7. The semiconductor device according to claim 4,
wherein the synthetic data output unit adjust a length of the synthetic data based on information about a data size of the associated data.

8. The semiconductor device according to claim 3,
wherein the access information includes outside output setup information that allows or disallows output of the address information outside,
wherein, when the outside output setup information allows output of the address information, the synthetic data output unit outputs synthetic data outside by synthesizing the address information output from the associative memory and the associated data output from the associated memory, and
wherein, when the outside output setup information disallows output of the address information, the synthetic data output unit does not output the address information output from the associative memory and outputs only the associated data output from the associated memory.

9. The semiconductor device according to claim 3,
wherein the associated memory includes:
internal associated memory that is accessibly provided in accordance with the address information in the associative memory and stores first associated data corresponding to the entry data; and
external associated memory that is accessibly provided in accordance with the address information in the associative memory and stores second associated data corresponding to the entry data,
wherein the controller accesses one of the internal associated memory and the external associated memory based on the access information stored in the additional register and address information and acquires one of first associated data and second associated data corresponding to the entry data, and
wherein the synthetic data output unit outputs synthetic data outside by synthesizing the address information output from the associative memory and one of first associated data and second associated data output from one of the internal associated memory and the external associated memory.
